(19) United States
(12) Patent Application Publication
(10) Pub. No.: US 2017/0004855 A1
(43) Pub. Date: Jan. 5, 2017

(54) PERPENDICULAR MAGNETIC RECORDING MEDIUM

(71) Applicant: Kabushiki Kaisha Toshiba, Tokyo (JP)

(72) Inventors: Kaori Kimura, Yokohama Kanagawa (JP); Soichi Oikawa, Hachioji Tokyo (JP)

(21) Appl. No.: 14/840,550

(22) Filed: Aug. 31, 2015

(30) Foreign Application Priority Data
Jun. 30, 2015 (JP) 2015-130779

(51) Int. Cl. G11B 5/66

(52) U.S. Cl. CPC G11B 5/66

(57) ABSTRACT

According to one embodiment, a perpendicular magnetic recording medium includes an underlying layer with convexes arranged with 1 to 20 nm intervals, and a multilayered amorphous magnetic recording layer formed on the underlying layer. The multilayered amorphous magnetic recording layer includes a first amorphous magnetic recording layer with a plurality of magnetic grains each formed on a corresponding convex to be widened toward its tip and being separated from each other at least in the convex side, a nonmagnetic protective layer covering at least a part of a sidewall of the magnetic particle, and a second amorphous magnetic recording layer formed on the nonmagnetic protective layer.

### CROSS-REFERENCE TO RELATED APPLICATIONS

This application is based upon and claims the benefit of priority from Japanese Patent Application No. 2015-130779, filed Jun. 30, 2015, the entire contents of which are incorporated herein by reference.

### FIELD

Embodiments described herein relate generally to a perpendicular magnetic recording medium.

### BACKGROUND

Magnetic recording media of nowadays often use a perpendicular magnetic recording scheme, and in this scheme, good perpendicular orientation of a recording layer and isolation of particles of a magnetic substance must be secured concurrently. Conventionally, adopted is a granular structure in which particles of a ferromagnetic substance (such as CoPt alloy, FePt alloy, and CoPd alloy) are oriented perpendicularly in a matrix of an oxide (such as SiO_{X}, TiO_{X}, and AlO_{X}). However, as the number of particles per bit is reduced for increasing density of the medium, the size of particles of the magnetic substance becomes irregular. The irregularity of the particle size is mainly caused by asperity (convexity and concavity) of underlying layer, crystal grain size, and the like. Although many attempts have been made, the irregularity is still the problem. One reason is that both the granular structure and the crystalline anisotropy can be satisfied only by specific materials such as Ru and MgO, and another reason is that the recording layer itself is crystalline and grains therein grow uniquely. In contrast, if an amorphous magnetic recording layer is used, perpendicular orientation can be achieved without depending on an underlying layer and a shape of the underlying layer can be traced easily because there is no unique grain growth. That is, if an amorphous material is used for the magnetic recording layer, a structure with less irregularity of particle size will be created without consideration of a material of the underlying layer.

To create an underlying structure with convexity and concavity of less irregularity, a patterning process using nanoparticles and diblock copolymers has been proposed. In this process, an underlying for patterning of convexity and concavity is produced using nanoparticles and diblock copolymers as a mask, and the underlying with convexity and concavity is used to grow an amorphous recording layer thereon. However, conventionally proposed magnetic recording media having an amorphous magnetic recording layer are structured without a grain boundary material, and thus, there is a great risk of oxidization occurring in sidewalls. This is caused by rare-earth elements which very easily oxidize. There is a way to mix an anti-oxidization material such as Cr, Al, and the like in the amorphous magnetic recording layer; however, such an anti-oxidization material generally decreases perpendicular magnetic anisotropy Ku, and thus, a mixture ratio cannot be increased so much.

### BRIEF DESCRIPTION OF THE DRAWINGS

FIG. 1A is a cross-sectional view which shows an example of the structure of a perpendicular magnetic recording medium of an embodiment.

FIG. 1B is a cross-sectional view which shows an example of the structure of the perpendicular magnetic recording medium of the embodiment.

FIG. 1C is a cross-sectional view which shows an example of the structure of the perpendicular magnetic recording medium of the embodiment.

FIG. 1D is a cross-sectional view which shows an example of the structure of the perpendicular magnetic recording medium of the embodiment.

FIG. 1E is a cross-sectional view which shows an example of the structure of the perpendicular magnetic recording medium of the embodiment.

FIG. 2 is a schematic view of an example of arrangement pattern of convexes of an underlying layer.

FIG. 3 is a schematic view of an example of arrangement pattern of convexes of the underlying layer.

FIG. 4 is a schematic view of an example of arrangement pattern of convexes of the underlying layer.

FIG. 5 is a cross-sectional view which shows an example of a shape of convexes of the underlying layer.

FIG. 6 is a cross-sectional view which shows an example of a shape of convexes of the underlying layer.

FIG. 7 is a cross-sectional view which shows an example of a shape of convexes of the underlying layer.

FIG. 8 is a cross-sectional view which shows an example of a shape of convexes of the underlying layer.

FIG. 9A shows an example of a manufacturing method of the magnetic recording medium of the embodiment.

FIG. 9B shows an example of a manufacturing method of the magnetic recording medium of the embodiment.

FIG. 9C shows an example of a manufacturing method of the magnetic recording medium of the embodiment.

FIG. 9D shows an example of a manufacturing method of the magnetic recording medium of the embodiment.

FIG. 9E shows an example of a manufacturing method of the magnetic recording medium of the embodiment.

FIG. 10 shows an example of a cross-section of the magnetic recording medium of the embodiment.

### DETAILED DESCRIPTION

In general, according to one embodiment, a perpendicular magnetic recording medium includes a substrate, an underlying layer formed on the substrate, the underlying layer including a plurality of convexes arranged with 1 to 20 nm intervals, and a multilayered amorphous magnetic recording layer formed on the underlying layer.

The multilayered amorphous magnetic recording layer of the embodiment is each formed on the surface of a convex of the underlying layer to widen therefrom, and includes a plurality of magnetic grains each having a magnetization easy axis in a direction perpendicular to the layer surface, the plurality of magnetic grains are formed separately at least in an area near the convexes of the underlying layer.

Furthermore, each magnetic particle includes a first amorphous magnetic recording layer, a nonmagnetic protective layer formed on the surface of the first amorphous magnetic recording layer to cover at least a part of the sidewall of the magnetic particle, and a second amorphous magnetic recording layer formed on the nonmagnetic protective layer.

According to an embodiment, if a nonmagnetic protective layer formed of Pt or the like is interposed in a multilayered amorphous magnetic recording layer for anti-oxidization, the nonmagnetic protective layer is interposed between the layers and further adheres to the sidewall of the magnetic particle in a sputtering process. Since the sidewall is covered with the nonmagnetic protective layer, oxidization can be prevented and corrosion resistance of the magnetic recording medium can be improved.

Hereinafter, embodiments will be described with reference to accompanying drawings.

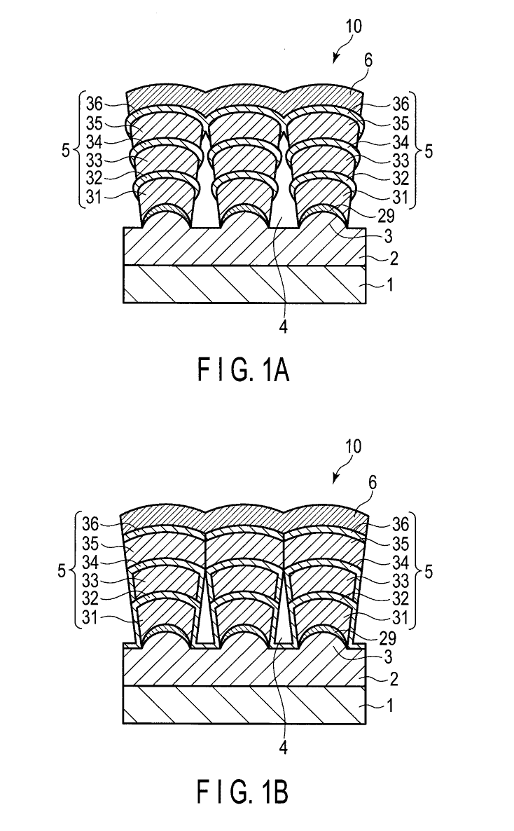

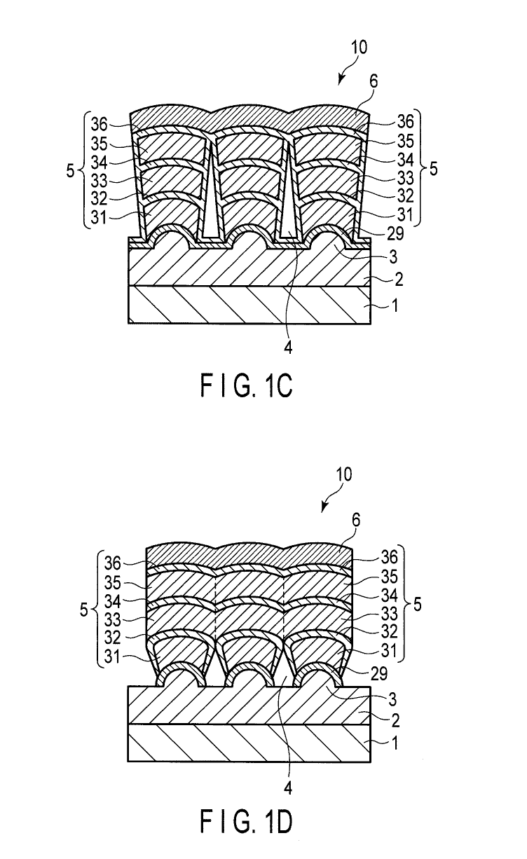

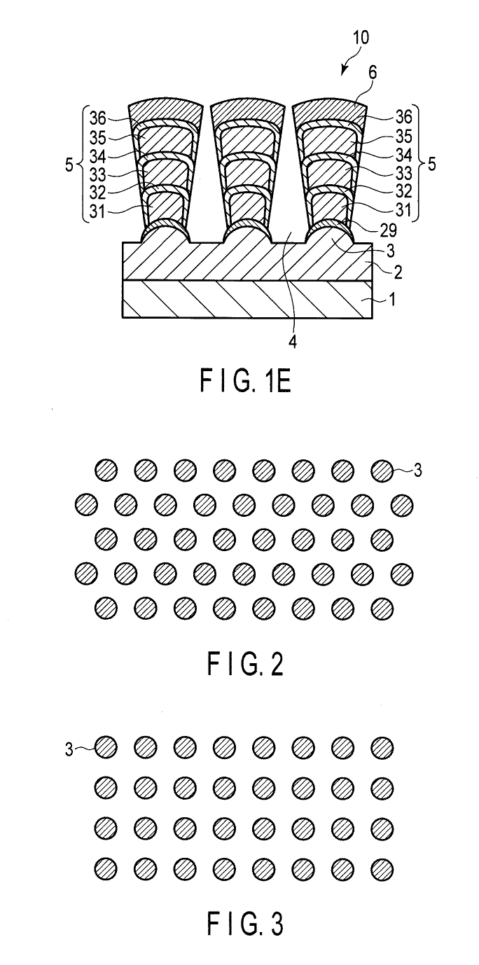

FIG. 1A is a cross-sectional view which shows an example of the structure of a perpendicular magnetic recording medium of an embodiment.

A magnetic recording medium 10 includes, on a substrate 1, a soft magnetic undercoating layer which is not shown, convex/concave underlying layer 2 having convexes 3, multilayered amorphous magnetic recording layer 5, and protective layer 6. An anti-oxidization layer 29 may optionally be provided between the convex/concave underlying layer 2 and the multilayered amorphous magnetic recording layer 5. The convex/concave underlying layer 2 is, as is evident from its name, an underlying layer having convexes 3. First, second, and third amorphous magnetic recording layers 31, 33, and 35 grow into pillars tracing the shape of the convex 3. The convex pattern is formed, when the substrate 1 is viewed from the above, in a low distribution manner with a pitch (that is, an interval between barycenters) of approximately 4 to 20 nm. The first to third amorphous magnetic recording layers 31, 33, and 35 of the multilayered amorphous magnetic recording layer 5 grow selectively on the projecting convexes 3 and accumulate on the convexes 3 gradually widening from the substrate 1 side to the surface side. Since the first to third amorphous magnetic recording layers 31, 33, and 35 are not crystalline, they accurately trace the shape of the convex 3 without a unique grain growth. Furthermore, the multilayered amorphous magnetic recording layer 5 includes first, second, and third nonmagnetic protective layers 32, 34, and 36 provided with the first, second, and third amorphous magnetic recording layers 31, 33, and 35, respectively. Therein, the first to third nonmagnetic protective layers 32, 34, and 36 are curved to correspond to the shape of the convex 3, not parallel to the substrate 1. Furthermore, in a grain boundary 4 between magnetic grains, the nonmagnetic protective layers adhere to the sidewalls of the magnetic grains. With nonmagnetic protective layers 32, 34, and 36 on the sidewalls, the amorphous layers 31, 33, and 35 are not exposed and can be covered partly or entirely in the grain boundary 4. In general, an amorphous rare earth-transition metal (RE-TM) alloy is used as a material for an amorphous magnetic layer, and thus, the amorphous magnetic layer easily oxidizes. However, with nonmagnetic protective layers 32, 34, and 36 provided with the gap of the grain boundary 4, the oxidization can be prevented. The boundary 4 between the pillar structures of the magnetic grains may be a gap or may be filled with the material of nonmagnetic protective layers 32, 34, and 36. Furthermore, the boundary may be formed of an oxide mainly composed of deposited rare earth material. In the proximity of the outermost surface, the amorphous magnetic recording layers of the multilayered amorphous magnetic recording layer 5 are formed almost continuously, and the protective layer 6 deposited thereon may be formed continuously as well. The materials used for these layers will be described later.

FIGS. 1B to 1E are cross-sectional views showing other examples of the structure of the perpendicular magnetic recording medium of the embodiment.

As shown in these figures, the multilayered amorphous magnetic recording layer of the perpendicular magnetic recording medium of the embodiment can be modified structurally in various ways aside from the structure shown in FIG. 1A.

FIG. 1B shows an example in which the layers are formed continuously in the proximity of the outermost surface. As in the example of FIG. 1A, the magnetic recording medium 10 includes, on the substrate 1, the soft magnetic undercoating layer which is not shown, convex/concave underlying layer 2 having convexes 3, multilayered amorphous magnetic recording layer 5, and protective layer 6. The anti-oxidization layer 29 may optionally be provided between the convex/concave underlying layer 2 and the multilayered amorphous magnetic recording layer 5. As in the example of FIG. 1A, the amorphous magnetic recording layers 31 and 33 accumulate from the convexes 3 gradually widening toward the surface side. The amorphous magnetic recording layers 35 are formed continuously. Nonmagnetic protective layers 32 and 34 adjacent to the gaps 4 cover the sidewalls of the amorphous magnetic recording layers 31 and 33 partly or entirely. Nonmagnetic protective layers 36 and the protective layer 6 are formed continuously as being deposited on the continuously-formed amorphous magnetic recording layers 35.

FIG. 1C shows an example in which only nonmagnetic protective layers 36 in the outermost surface are formed continuously.

FIG. 1D shows an example in which two thirds of the layers from the surface side are formed continuously. The amorphous magnetic recording layers 31 grow to widen toward the surface side from the convexes of the convex/concave underlying layer 2. The gaps therebetween end where nonmagnetic protective layers 32 cover the amorphous magnetic recording layers 31, and the layers thereafter are formed almost continuously. Accordingly, the amorphous recording layers 33 and 35 and nonmagnetic protective layer 34 and 36 are formed continuously as being deposited on the continuously-formed amorphous magnetic recording layers 31.

FIG. 1E shows an example in which the recording layers are separated from each other and the protective layer 6 is disposed on each recording layer separately.

### <Amorphous Magnetic Recording Materials>

As amorphous magnetic recording materials, amorphous rare earth-transition metal (RE-TM) alloys are generally used.

Specifically, alloys such as Gd—Co, Gd—Fe, Tb—Fe, Gd—Tb—Fe, Tb—Co, Tb—Fe—Co, Nd—Dy—Fe—Co, and Sm—Co are used.

If a light rare earth group (such as Nd) is used, the magnetization is parallel to the transition metal, and thus, the alloy will be a ferromagnetic substance. If a heavy rare earth group (such as Gd, Tb, and Dy) is used, the magnetization is opposite to that of the transition metal, and thus, the alloy will be a ferrimagnetic substrate. Having an effect of decreasing saturated magnetization Ms, the ferrimagnetic substance increases a coercivity Hc.

The transition metal will be Fe, Co, and Ni, for example. However, if Ni is used, the Curie temperature Tc becomes less than a room temperature in many cases. Thus, Ni is not used generally.

The oxidization of the magnetic material can be controlled by adding a little amount of easily-oxidized material such as Cr, Si, Ti, and Al to the alloy as an additional element. The anti-oxidization effect is also achievable by mixing a little amount of a rare metal such as Au, Pt, and Ag in the alloy as an additional element. The additional element can be added to the alloy in a composition ratio less than or equal to 30 at %, or less than or equal to 10 at % of the entire elements. If the amount of the additive is too much, the saturated magnetization Ms tends to decrease and the perpendicular magnetic anisotropy Ku tends to decrease.

One of the amorphous magnetic recording layers, that is, one amorphous magnetic recording layer which is not separated by a nonmagnetic protective layer in the multilayered recording layer can be set to a thickness of more than or equal to 1 nm, or to a thickness of more than or equal to 3 nm. If the film thickness is too thin, the element diffusion in the adjacent layers becomes great, and the perpendicular orientation itself tends to be weak.

In the multilayered amorphous magnetic recording layer, the composition of each layer may be the same or different. For example, the layer at the lower side near the underlying may be formed of TbFeCo alloy having high Ku while the layer at the upper side near the protective layer may be formed of TbCoCr alloy having low Ku. With such a structure, a magnetization reversal with respect to a medium having high Ku can be performed easily, and both the thermal fluctuation resistance and the write facility are achievable.

### <Shape of Amorphous Magnetic Recording Layer>

The multilayered amorphous magnetic recording layer 5 is deposited on the convex/concave underlying layer 2 and the magnetic particle thereof is formed in a pillar-like structure as in FIG. 1. The amorphous magnetic recording layers are initially deposited separately on the convex/concave underlying layer. However, the size of the magnetic particle increases with the growth of thickness and the magnetic grains are eventually coupled to each other. Note that the magnetic grains may be coupled together in the outermost surface area or may grow into pillars without any coupling. If the layer is structured such that the total thickness is 20 nm and only the lower most layers of 2 nm are separated from each other while the other parts of the layer is a continuous amorphous layer, improved corrosion resistance and stabilized coercivity are not likely obtainable. Thus, the multilayered amorphous magnetic recording layers of the embodiment should be separated from each other in at least one third of the total thickness of the layer structure. The state of the separation can be observed by a cross-sectional transmission electron microscope (TEM) method or the like.

If, for example, TbCoCr alloy is grown on the convex/concave underlying layer, the basic structure of the underlying layer is kept until it grows in thickness of approximately 30 nm, but thereafter, the pillar structure composed of a plurality of magnetic grains coupled together is formed. Therefore, the recording layer can be achieved in the thickness of 30 nm or less.

The multilayered amorphous magnetic recording layer can be deposited to a total thickness of 3 to 30 nm by a sputtering method. If the thickness is less than 3 nm, an effective perpendicular magnetic layer cannot be achieved by the influence of the initial layer and the magnetic recording capacity tends to be insufficient. If the thickness is greater than 30 nm, the head field required for the magnetization reversal tends to be insufficient. Here, the total thickness means a thickness of the multilayered amorphous magnetic recording layer as a whole including two or more amorphous magnetic recording layers and one or more nonmagnetic protective layers. That is, the anti-oxidization layer and the protective layer are not included in the total thickness.

During the growth, pressure of a process gas can be set in the range of 0.5 to 10 Pa for better separation of the amorphous magnetic recording layers. If the gas pressure is below 0.5 Pa, particle separation tends to be insufficient. If the gas pressure is beyond 10 Pa, longitudinal distribution of the thickness and composition tends to occur.

Note that, as in the amorphous magnetic recording layer of the present embodiment, magnetic grains are those are disposed on the convex/concave underlying layer and are entirely or partly isolated. Otherwise, the magnetic particle may refer to a granular part of the granular structure. That is, the magnetic grains are not the nanoparticles used in a template.

### <Nonmagnetic Protective Layer>

Now, the nonmagnetic protective layer will be described. The nonmagnetic protective layer is inserted between amorphous magnetic recording layers to protect sidewalls of the pillar structure formed of the magnetic particle of the amorphous magnetic recording layer. The nonmagnetic protective layer may be formed of a metal such as Pt, Pd, Au, Cu, Cr and Al or of an alloy mainly containing these metals.

A phrase “mainly containing” means that the metal is contained more than or equal to 50% in the alloy. The above material should be contained mainly and other elements may be added as an additive. For example, Pd containing 10 at % of Ag, Pt containing 30 at % of B, Cr₂N, and the like are covered by this definition.

The above materials are a rare metal or a material which easily becomes passivity, and thus, they will be effective as an anti-oxidization protective layer. Furthermore, since Pt is easily polarized and Pd is deformable, they are also effective to assist perpendicular anisotropy such as perpendicular magnetic anisotropy.

The nonmagnetic protective layer is inserted between amorphous magnetic recording layer by sputtering, CVD, or ALD, for example. The nonmagnetic protective layer is not necessarily amorphous and may be crystalline. As described later, the nonmagnetic protective layer is thin and it does not substantially change the shape of the whole layer.

The shape of the nonmagnetic protective layer is, as with the amorphous magnetic recording layer, a curved layer corresponding to the shape of the convex. The layer is thickest at its center and may become thinner as reaching the sidewalls. Unlike a general artificial lattice or the like, the nonmagnetic protective layer requires a certain thickness. For example, an artificial lattice may have a thickness a few angstroms while the nonmagnetic protective layer may have a thickness in the thickest part of 0.5 nm at minimum and 3 nm as needed. If the thickness of the nonmagnetic protective layer is too thin, the anti-oxidization effect tends to decrease. If the thickness is too much, coupling exchange of adjacent amorphous magnetic recording layers is cut and the particle of the recording layer tends to lose the magnetization reversal ability as a single magnetic substance. The nonmagnetic material adhered to a sidewall sometimes may not be directly observed by a TEM or the like, but in such a case, the adhesion can be confirmed by elementary analysis such as EDX or EELS.

If the number of nonmagnetic protective layers is too many, the ratio of the amorphous magnetic recording layers decreases, and consequently, the perpendicular magnetic anisotropy Ku and the magnetization Ms decrease. In consideration of this point, the number of the nonmagnetic protective layers will be set to one to five. Furthermore, each of the amorphous magnetic recording layers may have a thickness of 3 nm or more. If the thickness is below 3 nm, the perpendicular magnetic anisotropy Ku becomes insufficient by an influence of the initial layer. The ratio of the nonmagnetic protective layers with respect to the total thickness of the magnetic recording layer, that is, the sum of the thicknesses of the amorphous magnetic recording layer and the nonmagnetic protective layer is set to one third or less. Since the total thickness of the amorphous magnetic recording layers is 30 nm or less, the total thickness of the nonmagnetic protective layer is set to 10 nm or less. The nonmagnetic protective layer may decrease the coercivity Hc of the recording layers. In consideration of this point, the composition of the amorphous material may be changed such that Hc can fully be secured. In consideration of the protection of sidewalls, the nonmagnetic protective layer may be formed under different conditions from those of the amorphous magnetic recording layers. Specifically, if sputtering is used for the formation, the nonmagnetic protective layers may be formed in a lower pressure to better surround the sidewalls.

If there are several nonmagnetic protective layers, the layers may be formed of the same material or different materials. Similarly, the layers may have the same thickness or different thicknesses.

### <Magnetic Characteristics of Amorphous Magnetic Recording Layer>

The magnetic recording medium of the present embodiment exerts a magnetization rotational magnetic characteristic. The magnetic characteristic can be measured by a vibration sample magnetometer (VSM) or a Kerr effect measurement device.

The coercivity Hc of the perpendicular magnetic recording layer can be set to 2 kOe or more. If the coercivity Hc is below 2 kOe, high surface recording density becomes difficult to achieve.

The perpendicular magnetic recording layer has a perpendicular squareness ratio of 0.9 or more. The perpendicular squareness ratio is derived by dividing remaining magnetization Mr by saturated magnetization Ms. If the perpendicular squareness ratio is below 0.9, the perpendicular orientation is deteriorated or the thermal stability is partially decreased.

If a magnetic field at a crossing point of a tangent of a magnetization curve in the proximity of the coercivity Hc and a negative saturated value is given a nucleation field Hn, Hn is less than Hc. Hn should be increased as much as possible in consideration of good read output, thermal fluctuation resistance and data erase resistance during record of adjacent tracks. However, increasing Hn means increasing a gradient α of the magnetization curve in the proximity of Hc, and consequently, the signal-to-noise ratio tends to decrease.

In general, the gradient α of the magnetization curve in the proximity of the coesivity Hc is given by

α=4πdM/dH|H=Hc,

where M is the magnetization and H is an external magnetic field. In commercially-available perpendicular magnetic recording media of granular type, the gradient α is set to approximately 2 since relatively strong interparticle coupling achieves a good recording and reading characteristic in total. However, high linear recording density and high signal-to-noise ratio are obtainable with weak interparticle coupling. In perpendicular magnetic recording media of granular type, if the gradient α is greater than 3, the interparticle coupling tends to be too strong. Furthermore, if the gradient α is 5 or more, the magnetic grains do not show independent magnetic reversals but tend to show reversals influenced by those of adjacent particles.

### <Anti-Oxidization Layer>

An anti-oxidization layer can be provided between the concave/convex underlying and the amorphous magnetic recording layers. The anti-oxidization layer prevents a contaminant on the surface of the convex/concave underlying such as oxygen, oxide, and hydroxide (and rarely nitride, chloride, and fluoride) from transferring to the amorphous magnetic recording layer which easily reacts with the contaminant. Therefore, the anti-oxidization layer is formed of a material which does not react with the recording layer. Specifically, a rare metal such as Pd, Ru, Pt, Au, Cu, and Ag, and a transition metal such as Ti, Cr, Fe, Co, Ni, Ta, and W are adoptable. Furthermore, a material without crystal grain is used for better traceability of the shape of the convex. The above materials do not have large crystal grains in a few nm thickness but some of them have 5 to 6 nm crystal grains in an approximately 10 nm thickness. The crystal grain of the anti-oxidization layer does not correspond to the shape of the convex/concave underlying. Thus, the amorphous magnetic recording layer tends to grow along the crystal grain of the anti-oxidization layer. In consideration of this matter, an amorphous material is used when the anti-oxidization layer is thick. For example, Ni—Ta, Cr—Ti, and Zr—Fe are exemplary amorphous materials. An amorphous layer can be formed through sputtering using a combination of a material of a first group including Ti, Ta, Hf, Nb, and Zr and a material of a second group including Cr, Fe, Co, Ni, Cu, Mo, Rh, Pd, and Ir.

The amorphous material used may not be magnetized. If the amorphous material is magnetized, the magnetic characteristic of the amorphous material is changed by oxidization and the magnetic characteristic of the recording layer which is continuously grown thereon is influenced as well.

The thickness of the anti-oxidization layer may be increased from the anti-oxidization standpoint.

For example, if the anti-oxidization layer is below 2 nm, the deposition of a continuous layer on the layer is difficult to achieve and anti-oxidization performance will decrease. On the other hand, if the thickness is too much, the convex/concave shape tends to be even and the separation of magnetic grains is difficult to achieve. For example, if the anti-oxidization layer has a thickness of 30 nm or more, the layer becomes continuous and the amorphous magnetic recording layer thereon tends to have magnetic characteristic of magnetic wall transfer type. In consideration of the above, the anti-oxidization layer is formed in the range of 2 to 30 nm.

### <Pattern of Underlying Layer>

FIGS. 2 to 4 schematically show examples of arrangement patterns of convexes of the underlying layer, as being viewed from the above.

The convexes 3 of the underlying layer are arranged regularly. When the arrangement pattern of the convexes 3 of the underlying layer is viewed from the above, the convexes 3 may be circles (or polygons) in a close-packed arrangement with an arrangement pitch of 4 to 20 nm as shown in FIG. 2 or may be circles (or polygons) in a square matrix arrangement with the same arrangement pitch as shown in FIG. 3.

If the arrangement pitch is greater than 20 nm, the recording density of the magnetic recording medium tends to decrease. Furthermore, if the arrangement pitch is below 4 nm, recorded data tend to vanish by the thermal fluctuation effect.

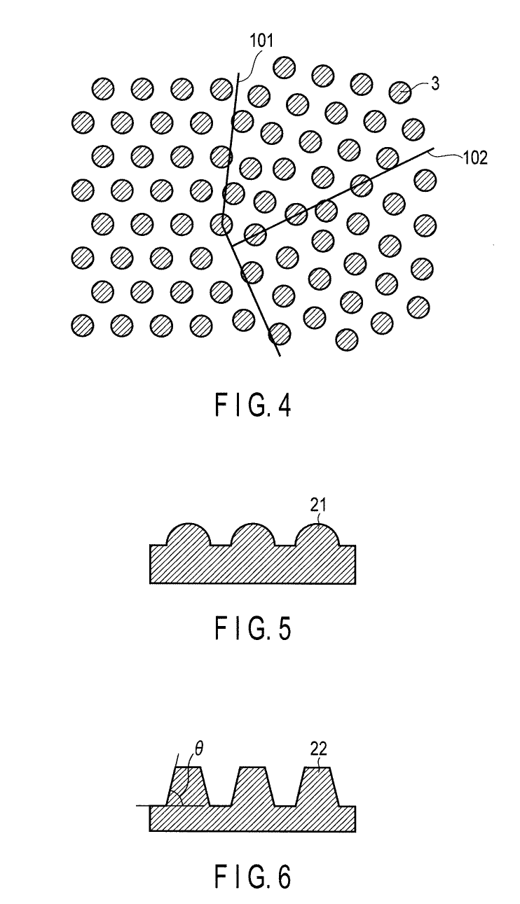

Note that the arrangement pitch of the convexes in the arrangement pattern is represented by a distance between centers of the convexes. The arrangement pattern may be a combination of domains or regularly arranged patterns each having an area of a few hundred nm or more defined by, for example, border lines 101 and 102 in FIG. 4. Furthermore, the arrangement may not necessarily be a complete close-packed arrangement.

Grooves in the convex arrangement may have a depth of 3 nm to 30 nm. If the depth is below 3 nm, sputtered atoms enter the grooves and affect the isolation of grown magnetic grains. If the depth is beyond 30 nm, the soft magnetic undercoating layer becomes too distant from the underlying layer and the recording density tends to decrease.

Furthermore, the underlying layer has a plurality of convexes arranged with 1 to 20 nm intervals. This means that the groove between convexes has a width of 1 to 20 nm.

If the width of the groove is less than 1 nm, the magnetic grains formed on the layer are not separated by the grooves. The magnetic grains are supported by adjacent particles such that the layer formed evenly. Therefore, if the groove is formed with a depth less than 3 nm and width less than 1 nm, the layer tends to become a substantially flat substrate.

FIGS. 5 to 8 show cross-sectional views of examples of the shape of convex of the underlying layer.

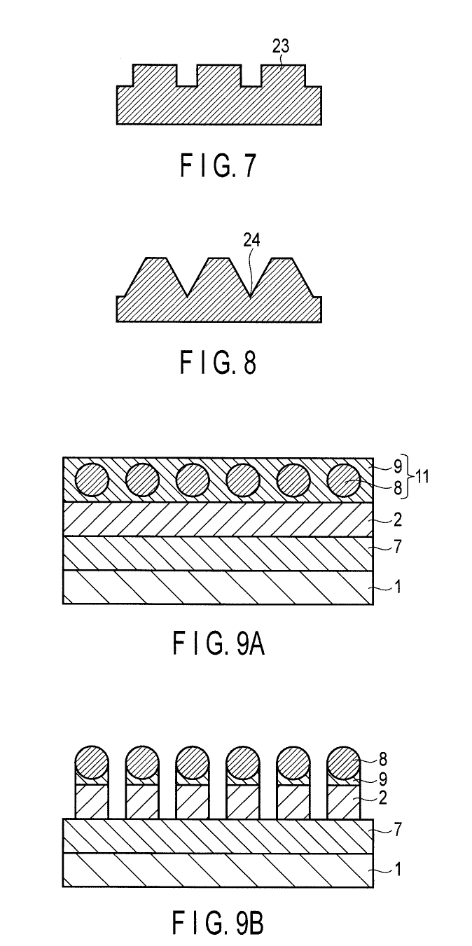

The convexity/concavity of the underling layer may be shaped as a half circle 21 as in FIG. 5, trapezoid 22 as in FIG. 6, tube 23 as in FIG. 7, and v-shaped groove 24 as in FIG. 8. If the trapezoidal shape is adopted, an angle θ of side surfaces with respect to the direction parallel to the bottom of the groove in the underlying layer, that is, the taper of the trapezoid needs to be considered. If angle θ (taper) is less than 30°, the perpendicular orientation may be made with respect to the side surfaces and the perpendicular magnetization layer with respect to the substrate may not be achieved.

### <Materials of Underlying Layer>

Various materials selected with consideration of corrosiveness and resistance can be used for the underlying layer.

Materials used for the underlying layer will be an inorganic material such as C and Si, metal material such as Al, Ti, Cr, Mn, Fe, Co, Ni, Cu, Zn, Ge, Zr, Nb, Mo, Ru, Rh, Pd, Ag, In, Hf, Ta, W, Ir, Pt, and Au, alloy of these metals such as CrTi, and NiW, oxide, and nitride. Especially, materials such as C, Al, Ta, Fe, Pt, and Au achieve easy formation of the convex/concave pattern and good affinity with an amorphous material.

A buffer layer may be interposed between the underlying layer and the amorphous magnetic material. If an amorphous magnetic recording layer formed of TbFeCo is directly deposited on the underlying layer formed of Ag, for example, Ag may disperses in the layer and cancel the perpendicular magnetization. The buffer layer, if provided, controls the reaction between the underlying layer and the amorphous magnetic recording layer. Furthermore, if an amorphous magnetic recording layer formed of TbFeCo is directly deposited on the underlying layer formed of Au produced through an RIE process with gaseous CF₄, the surface of the Au underlying is contaminated by fluorine, and the same adverse effect occurs. If the amorphous magnetic recording layer is deposited relatively thick, this problem will be solved; however, such a thick amorphous magnetic recording layer is distant from the soft magnetic undercoating layer and consequently, the recording density may decrease.

In that case, the buffer layer formed of Ta, Al, and NiTa having a few nm will be formed to control the diffusion and achieve the desired perpendicular magnetic recording layer.

Note that, if the anti-oxidization layer is adopted, the buffer layer may be interposed between the convex/concave underlying layer and the anti-oxidization layer.

### <Treatment Method of Underlying Layer>

The underlying layer can be treated through various methods.

For example, nanoparticles having a diameter of a few to a few tens of nanometers are arranged uniformly to produce an underlying layer with convexity/concavity. If nanoparticles of less size irregularity are used, size irregularity of the underlying layer can be low. A self-organizing material such as diblock copolymer or the like, an alumina nanohole material, and a mesoporous material can be used as nanoparticles.

If anodized alumina is used in a template, regularly arranged nanoholes can be obtained by depositing an Al thin film on a substrate in advance, producing electrodes, and then applying a field thereto in an acid solution.

To explain a case of using a mesoporous material, mesoporous silica will be exemplified. Initially, tetraethoxysilane (TEOS), triblock copolymer, HCI, ethanol, and water are mixed and diluted to a concentration suitable for monolayer arrangement, and the diluted mixture is applied on a substrate as a monolayer by a spincoating method. Then, the block copolymer is removed by baking to produce a regular pattern of holes of a few nm on the substrate. The pattern is basically the same as those of nanoparticles and diblock copolymers; however, convexity and concavity are reversed such that the dots denoted by reference number 3 in FIG. 2 are formed as concavities in this example. If a metal material is embedded to the concavities by electroforming or sputtering and an etching process is performed, the convexity and concavity of the pattern can be reversed.

Furthermore, a eutectic structure such as AlSi and AgGe can be used. Since the eutectic structure itself does not have convexity/concavity, an etching process is necessary to form convexity/concavity.

One of the above-cited materials is applied to a substrate on which an underlying layer material such as carbon is deposited, and an etching process such as RIE is performed to form convexity/concavity thereon to produce an underlying layer. When the pattern is transferred to the substrate, better hardness and adhesion can be achieved as compared to a case where nanoparticles and organic materials are directly used for the underlying layer.

The patterning of the underlying layer can be performed through various dry etching processes as circumstances demand. For example, if C is used in the underlying layer, an O₂ plasma etching process can be performed. If Si, Ge, Fe, Co, Cr, Ta, W, and Mo are used, a gaseous halogen etching process with CF₄, CF₄/O₂, CHF₃, SF₆, and Cl₂ can be performed. Furthermore, if a rare metal which is unsuitable for O₂ or halogen etching is used, an ion milling with an inert gas or the like can be performed. If the gaseous halogen etching process is performed, the layer must be fully washed with water after the process.

The patterning of the underlying layer can be performed through wet etching processes instead. Through a wet etching process, a large number of substrates can be treated at once and the productivity increases. For example, a wet etching process with hydrofluoric acid or alkaline etching solution is performed to remove the grain boundary of Si and Ge of the eutectic structure.

### <Nanoparticles>

Nanoparticles used for the underlying layer treatment may have a size of 1 to a few tens of nanometers. The shape of nanoparticles is a sphere in many cases, but may be a tetrahedron, rectangular parallelepiped, octahedron, triangle prism, hexagonal prism, or cylinder, for example. In consideration of regular arrangement, a shape of high symmetry is used. The nanoparticles with less size irregularity are used to increase arrangement in the application process. For example, in the manufacture of an HDD medium, the size irregularity may be set to 20% or less, or may be reduced to 15% or less. If the size irregularity is reduced, the HDD medium with less jitter noise can be achieved. If the irregularity exceeds 20%, the medium signal-to-noise tends to decrease with more jitter noise.

The nanoparticles can be formed of a metal, inorganic substance, or a compound thereof. Specifically, Al, Si, Ti, V, Cr, Mn, Fe, Co, Ni, Zn, Y, Zr, Sn, Mo, Ta, and W are used, for example. Furthermore, an oxide, nitride, boride, carbide, and sulfide of these elements can be used, for example. The nanoparticles may be either crystalline or amorphous. For example, particles of core shell type such as Fe surrounded by FeO_{X} (x=1 to 1.5) can be used. The core shell type particles may be composed of different materials such as Fe₃O₄ surrounded by SiO₂. Furthermore, metal core shell type particles such as Co/Fe may be oxidized in their surfaces such that their core shell structure has three or more layers such as Co/Fe/FeO_{X}. If the main content is selected from the materials cited above, a compound with a rare metal such as Pt and Ag and the selected can be used. For example, such a compound will be Fe₅₀Pt₅₀.

The arrangement of nanoparticles is performed in a solution system and the nanoparticles are stably dispersed in the solution with protecting groups. In consideration of application to the substrate, the boiling point of a solvent can be set to 200° C. or less, or may be reduced to 160° C. or less. The solvent may be, for example, aromatic hydrocarbon, alcohol, ester, ether, ketone, glycol ether, alicyclic hydrocarbon, and aliphatic hydrocarbon. In consideration of the boiling point and applicability, the solvent may specifically be hexane, toluene, xylene, cyclohexane, cyclohexanone, propylene glycol monomethyl ether acetate (PGMEA), diglyme, ethyl lactate, methyl lactate, and tetrahydrofuran (THF). The nanoparticles are dispersed in the solvent and are applied to the substrate as a monolayer through, for example, a spin coating method, dip coating method, or Langmuir-Blodgett (LB) method.

### <Eutectic>

Through a vapor deposition or sputtering process of two or more elements, a eutectic structure is prepared. As a eutectic structure, Al—Ge and Ag—Ge are well-known. If an Ag—Ge eutectic structure in which Ag is arranged in a cylindrical manner is used, the desired convex/concave structure can be obtained. At that time, the composition ratio may be set to approximately Ag₂₀Ge₈₀ to Ag₅₀Ge₅₀. If the Ag—Ge structure is soaked into 10% hydrofluoric acid for a few minutes, Ge is dissolved and only Ag can be maintained selectively.

### <Embedding>

A process to even out the medium by embedding may be added to the manufacturing process of the present embodiment. Embedding is in many cases performed by a sputtering process which targets an embedding material because of its easiness; however, embedding may be performed by other processes such as ion beam vapor deposition, chemical vapor deposition (CVD), and atomic layer deposition (ALD). If CVD or ALD is used, highly-tapered sidewalls of the magnetic recording layer can be embedded with high rate. Furthermore, if the substrate is biased during the embedding, a high aspect pattern can be embedded without gap. Alternately, a resist such as spin-on-glass (SOG) and spin-on-carbon (SOC) may be subjected to a spin coating process and hardened by a thermal treatment.

As an embedding material, SiO₂ can be used.

However, no limitation is intended thereby, and an embedding material may be other materials whose hardness and evenness are suitable. For example, amorphous metals such as NiTa and NiNbTi are suitable as an embedding material because they are easily evened. Materials mainly containing C such as CN_{X} and CH_{X} are suitable because they harden and improve adhesion to DLC. Furthermore, oxide and nitride of SiO₂, SiN_{X}, TiO_{X}, and TaO_{X} can be used as an embedding material wherein 0≦x≦3. Note that, if an embedding layer contacts the magnetic recording layer and produces a reaction product, one protective layer can be interposed between the embedding layer and the magnetic recording layer. The protective layer may be nonoxides of Si, Ti, and Ta, for example.

### <Formation of Protective Layer and Aftertreatment>

To increase coverage with respect to the convexity and concavity, the carbon protective layer may be formed through a CVD method. Alternately, a sputtering method or a vacuum vapor deposition method may be used. Through a CVD method, a DLC layer containing a large amount of sp3 coupling carbon can be formed. If the thickness is below 2 nm, the coverage will be poor, and if the thickness is 10 nm or more, magnetic spacing between a recording and reading head and a medium increases, and consequently, the SNR tends to decrease. A lubricant can be applied on the protective layer. The lubricant may be, for example, perfluoropolyether, fluoroalcohol, and fluorinated carboxylic acid.

### <Soft Magnetic Undercoating Layer>

As to a recording magnetic field used to magnetize a perpendicular magnetic recording layer, a soft magnetic undercoating layer (SUL) passes the recording magnetic field from a monomagnetic pole head horizontally and returns the recording magnetic field to a magnetic head side. That is, the soft magnetic undercoating layer (SUL) functions as a part of the magnetic head. The soft magnetic undercoating layer applies a steep and sufficient perpendicular magnetic field to the recording layer and improves recording and reading efficiency. The soft magnetic undercoating layer may be formed of a material containing Fe, Ni, or Co. Specifically, such a material may be: FeCo alloy such as FeCo, and FeCoV; FeNi alloy such as FeNi, FeNiMo, FeNiCr, and FeNiSi; FeAl and FeSi alloy such as FeAl, FeAlSi, FeAlSiCr, FeAlSiTiRu, and FeAlO; FeTa alloy such as FeTa, FeTaC, and FeTaN; and FeZr alloy such as FeZrN. Additionally, a material of microcrystalline structure such as FeAlO, FeMgO, FeTaN, and FeZrN containing at least 60 at % of Fe may be used or a material of glanular structure in which micro crystal particles are dispersed within a matrix may be used. Additionally, a Co alloy containing Co and at least one of Zr, Hf, Nb, Ta, Ti, and Y may be used. The Co alloy contains at least 80 at % of Co. The Co alloy tends to form an amorphous layer if it is formed through a sputtering method. Since an amorphous soft magnetic material does not possess crystalline magnetic anisotropy, crystallization defect, or grain boundary, it shows excellent soft magnetization and is effective for noise reduction of the medium. The amorphous soft magnetic material may be, for example, CoZr alloy, CoZrNb alloy, and CoZrTa alloy.

An additional underlying layer may be provided below the soft magnetic undercoating layer to improve the crystallization of the soft magnetic undercoating layer or the adhesion to the substrate. Such an additional underlying layer may be formed of Ti, Ta, W, Cr, or Pt, or an alloy of these elements, or an oxide or nitride of these elements.

To prevent spike noise, the soft magnetic undercoating layer may be divided into a plurality of layers with Ru of 0.5 to 1.5 nm inserted therebetween such that ferromagnetic coupling is created in the layers. Alternately, a hard magnetic layer of CoCrPt, SmCo, and FePt which possess longitudinal anisotropy or a pin layer formed of an antiferromagnetic substance such as IrMn, and PtMn and a soft magnetic layer may be coupled by exchange coupling. To control an exchange coupling force, magnetic layers (such as Co) or nonmagnetic layers (such as Pt) may sandwich each Ru layer.

### EXAMPLES

### Example 1

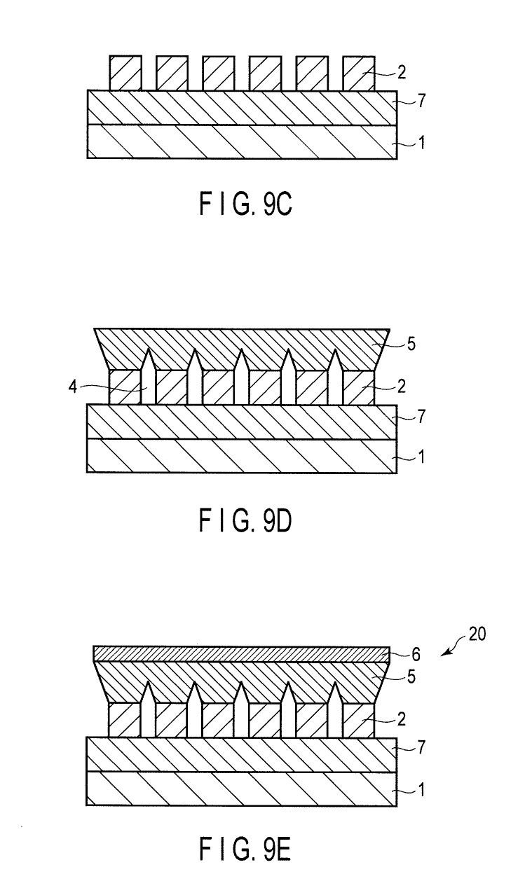

FIGS. 9A to 9E show an example of manufacturing method of a magnetic recording medium of the present embodiment.

As shown in FIG. 9A, a soft magnetic undercoating layer 7 formed of CoZrNb with a thickenss of 50 nm and an underlying layer 2 formed of C with a thickness of 20 nm used for treatment are formed on a glass substrate 1. Thereupon, FeO_{X} nanoparticles 8 having a diameter of 7 nm are applied in a single layer fashion. Polystyrene of 1000 molecule weight is adhered to the nanoparticles 8 as a protective group and the nanoparticles 8 are arranged on the substrate with a pitch of 10 nm. After the arrangement, the nanoparticles 8 form a hexagonal close-packed pattern as in FIG. 2.

As shown in FIG. 9B, the underlying layer 2 formed of C for treatment is subjected to dry etching using the FeO_{X} nanoparticles 8 as masks such that the underlying layer 2 and polystyrene around the nanoparticles 8 are etched. Consequently, convexities are formed on the substrate 1. This process is performed by, for example, an induction coupling plasma (ICP) RIE apparatus with O₂ used as a process gas, a 0.1 Pa chamber pressure, coil RF power of 40 W and platen RF power of 40 W, and etching time of 40 s. Through this process, the C underlying layer 2 is etched and convexity and concavity pattern of 15 nm is formed.

As shown in FIG. 9C, FeO_{X} nanoparticles 8 are removed from the substrate 1. The substrate 1 is soaked in hydrochloric acid of 1 wt % concentration for 10 minutes such that the FeO_{X} nanoparticles 8 are removed from the substrate 1. The substrate 1 is cleansed with pure water to prevent corrosion by a hydrochloric acid residue.

Then, as shown in FIG. 9D, an amorphous magnetic recording layer is deposited on the C underlying layer 2 on the substrate 1. Initially, an anti-oxidization layer of NiTa with a thickness of 5 nm (not shown) is deposited, and then, Tb₃₀Co₇₀ with a thickness of 5 nm and Pt with a thickness of 1.5 nm are deposited. Then, Tb₃₀Co₇₀ with a thickness of 5 nm and Pt with a thickness of 1.5 nm are twice further deposited thereon. Consequently, a multilayered amorphous magnetic recording layer including three Tb₃₀Co₇₀ layers and three Pt layers are layered alternately is obtained. The thickness of the multilayered amorphous magnetic recording layer is 19.5 nm in total.

Furthermore, as shown in FIG. 9E, a DLC protective layer with a thickness of 4 nm is deposited on the multilayered amorphous magnetic recording layer 5 through a chemical vapor deposition (CVD) and a lubricant (not shown) is applied thereto. Consequently, a magnetic recording medium 20 is obtained.

The magnetic recording medium 20 obtained as above was evaluated by a Kerr effect measurement device. Consequently, the squareness ratio of 1, Hc=3.8 kOe, Hn=1.5 kOe, and Hs=6.4 kOe were confirmed. Furthermore, a loop gradient α in the proximity of the coercivity Hc was 1.9. From the curve of the magnetization, the medium 20 is estimated not a magnetic wall transfer type but a reverse mode in which magnetically isolated magnetic grains are rotated magnetically. The magnetic recording medium was incorporated in a spin stand and data were written thereto with the recording density of 500 kFCI. Consequently, a clear reading waveform was confirmed.

Then, after the recording and reading test, the magnetic recording medium 20 was evaluated by the Kerr effect measurement device, Hc=3.7 kOe was confirmed.

Furthermore, a cross-sectional structure of the magnetic recording medium 20 obtained as above was scanned by a scanning transmission electron microscopy and a bright-field image was obtained.

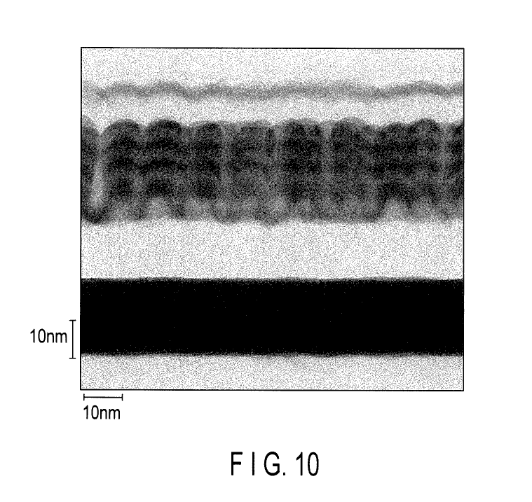

FIG. 10 shows the obtained bright-field image.

Note that the image of FIG. 10 is substantially the same as the schematic illustration of FIG. 1.

As shown in FIG. 10, in the magnetic recording medium 20 obtained as above, magnetic grains of first to third amorphous magnetic recording layers selectively grow on the convexities of projecting underlying layers. In the proximity of the convexities of the underlying layer, the particles are separated, and in the proximity of the top side, the particles are continuous as compared to the underlying layer side. The protective layers deposited thereon are more continuous in most part. The first nonmagnetic protective layer deposited on the first amorphous magnetic recording layer covers the sidewalls of the magnetic particle in the first amorphous magnetic recording layer. The second nonmagnetic protective layer on the second amorphous magnetic recording layer covers at least the sidewalls of the magnetic particle in the second amorphous magnetic recording layer, and the third nonmagnetic protective layer on the third amorphous magnetic recording layer covers at least the sidewalls of the magnetic particle of the third amorphous magnetic recording layer. That is, grain boundaries of the pillar structured magnetic grains of the multilayered amorphous magnetic recording layer are covered with the nonmagnetic protective layers. Therefore, the corrosion resistance of the magnetic recording medium is improved and stable coercivity can be obtained, and consequently, excellent magnetic recording performance can be achieved.

### Comparative Example 1

A magnetic recording medium of a comparative example was manufactured to have the same structure as example 1 except that amorphous magnetic recording layers of Tb₂₅Co₇₅ were directly deposited on a C underlying layer without a nonmagnetic protective layer and an anti-oxidization layer. Since the magnetostatic characteristics change depending on whether or not an anti-oxidization layer exists, Tb₂₅Co₇₅ was used for the amorphous magnetic recording layers to balance the magnetostatic characteristic of this comparative example with that of Example 1. The Kerr effect measurement device confirmed that the magnetostatic characteristic was less than or equal to ±0.5 kOe with Hc.

Recording and reading characteristics of the medium of example 1 and the medium of comparative example 1 were evaluated. A Guzik read/write analyzer RWA 1632 and a Guzik spinstand S1701 were used for the measurement. In evaluating the magnetic recording and reading characteristics, a head with a shielded magnetic pole for write and a TMR element for read was used. A recording frequency was measured as 1400 kBPI as the recording density. Table 1 shows the results.

TABLE 1

| | | Hc at manufac- | | Hc after |
|---|---|---|---|---|
| | Magnetic | turing process | SNR | measurement |
| | recording layer | [kOe] | [dB] | [kOe] |
| Example 1 | [Tb₃₀Co₇₀(5 nm)/ | 3.8 | 15 | 3.7 |
| | Pt(1.5 nm)]₃ | | | |
| Comparative | Tb₂₅Co₇₅(15 nm) | 3.5 | 5 | 1.5 |
| Example 1 | | | | |

Note that, for example, [Tb₃₀Co₇₀ (5 nm)/Pt (1.5 nm)]₃ in the table indicates a structure in which three layers of Tb₃₀Co₇₀ with a thickness of 5 nm and three layers of Pt with a thickness of 1.5 nm are layered alternately.

The medium of comparative example 1 exhibited a reading waveform with a lower signal-to-noise ratio (SNR) 10 dB lower than that of the medium of example 1.

Further study showed that Hc of the medium of comparative example 1 significantly decreased after the recording and reading test. This was apparently caused by a change in the magnetostatic characteristic by oxidization.

As can be understood from the above, the perpendicular magnetic recording medium with anti-oxidization layers indicates better recording and reading characteristics as compared to the perpendicular magnetic recording medium without an anti-oxidization layer. This is caused by an anti-oxidization effect of Pt inserted between the layers.

### Examples 2-1 to 2-4

As in Table 2, perpendicular magnetic recording media of examples 2-1 to 2-4 were manufactured through the same method as that of example 1 except that the number of Pt layers was changed to one, three, five and seven in examples 2-1 to 2-4, respectively. Furthermore, a perpendicular magnetic recording medium of comparative example 2 which does not at all include a nonmagnetic protective layer Pt was manufactured.

The manufactured perpendicular magnetic recording media were evaluated by the Kerr effect measurement device to measure Hc and Ms. Furthermore, Hc decay was measured to evaluate the anti-oxidization effect. The time required for Hc to become 75% from the initial value was measured in each example. Table 2 below shows results. The time required for Hc to decrease to 75% became longer with the number of Pt layers. When seven Pt layers were used, what was obtained was Ms of approximately 100 emu/cc even if the composition of TbCo was changed, and decrease of the initial Hc was observed. The following evaluation categories were noted according to how long it took for Hc to drop to 75% or less of its initial value. Seven days or less: ×; 8 to 20 days: Δ; more than 20 days: ◯.

As can be understood from the above, in the media including a Pt nonmagnetic protective layer or layers, an Hc decay reduction effect was achieved while the degree of the effect changes depending on the number of Pt layers.

TABLE 2

| | | | | Time required | | |
|---|---|---|---|---|---|---|
| | | | Initial | until Hc drops | | |
| | Number | Ms | Hc | to 75% of its | | Evalu- |
| | of Pt | [emu/cc] | [kOe] | initial value | | ation |
| Comparative | None | 150 | 5.0 | 1 | day | X |
| Example 2 | | | | | | |
| Example 2-1 | 1 | 350 | 4.2 | 14 | days | Δ |

| | | | | | |
|---|---|---|---|---|---|
| Example 2-2 | 3 | 260 | 3.8 | More than | ◯ |
| (same as | | | | 30 days | |
| Example 1) | | | | | |
| Example 2-3 | 5 | 210 | 2.2 | More than | ◯ |
| | | | | 30 days | |
| Example 2-4 | 7 | 100 | 1.5 | More than | ◯ |
| | | | | 30 days | |

### Example 3-1 to 3-5

As in Table 3, perpendicular magnetic recording media of examples 3-1 to 3-5 were manufactured through the same method as that of example 1 except that the thickness of Pt layers was changed to 0.3 to 4.5 nm in examples 3-1 to 3-5, respectively. The manufactured perpendicular magnetic recording media were evaluated by the Kerr effect measurement device to measure Hc and evaluate Hc decay.

The following evaluation categories were noted according to how long it took for Hc to drop to 75% or less of its initial value. Seven days or less: ×; 8 to 20 days: Δ; more than 20 days: ◯. Table 3 below shows the results.

TABLE 3

| | | | Time required | | |
|---|---|---|---|---|---|
| | Film thick- | Initial | until Hc drops | | |
| | ness of Pt | Hc | to 75% of its | | Evalu- |
| | [nm] | [kOe] | initial value | | ation |
| Comparative | None | 5.0 | 1 | day | X |
| Example 2 | | | | | |
| Example 3-1 | 0.3 | 4.6 | 8 | days | Δ |
| Example 3-2 | 0.5 | 4.3 | 20 | days | Δ |

| | | | | |
|---|---|---|---|---|
| Example 3-3 | 1.5 | 3.8 | More than | ◯ |
| (same as | | | 30 days | |
| Example 1) | | | | |
| Example 3-4 | 3 | 2.3 | More than | ◯ |
| | | | 30 days | |
| Example 3-5 | 4.5 | 1.5 | More than | ◯ |
| | | | 30 days | |

The Hc decay was suppressed with increasing the thickness of Pt layer whereas the value of Hc itself decreases, too. As can be understood from the above, in the media including a Pt nonmagnetic protective layer or layers, an Hc decay reduction effect was achieved while the degree of the effect changes depending on the thickness of Pt layers.

### Examples 4-1 to 4-5

As in Table 4, perpendicular magnetic recording media of examples 4-1 to 4-5 were manufactured through the same method as that of example 1 except that the material and thickness of nonmagnetic protective layers were changed. The manufactured perpendicular magnetic recording media were evaluated by the Kerr effect measurement device to measure Hc and evaluate Hc decay.

Table 4 shows the results.

TABLE 4

| | | | | Time required | |
|---|---|---|---|---|---|
| | | | Initial | until Hc drops | |
| | Mate- | | Hc | to 75% of its | Evalu- |
| | rial | Composition | [kOe] | initial value | ation |
| Example 1 | Pt | [Tb₃₀Co₇₀(5 nm)/ | 3.8 | More than | ◯ |
| | | Pt(1.5 nm)]₃ | | 30 days | |
| Example 4-1 | Pd | [Tb₃₀Co₇₀(5 nm)/ | 4.4 | More than | ◯ |
| | | Pd(1.5 nm)]₃ | | 30 days | |
| Example 4-2 | Au | [Tb₃₀Co₇₀(5 nm)/ | 4.1 | More than | ◯ |
| | | Au(1.0 nm)]₃ | | 30 days | |
| Example 4-3 | Cu | [Tb₃₀Co₇₀(5 nm)/ | 4.0 | More than | ◯ |
| | | Cu(1.0 nm)]₃ | | 30 days | |
| Example 4-4 | Cr | [Tb₃₀Co₇₀(5 nm)/ | 3.2 | More than | ◯ |
| | | Cr(0.5 nm)]₃ | | 30 days | |
| Example 4-5 | Al | [Tb₃₀Co₇₀(5 nm)/ | 5.1 | More than | ◯ |
| | | Al(0.5 nm)]₃ | | 30 days | |

Materials other than Pt were used, and the Hc decay suppression effect was confirmed in each example as in the examples with Pt protective layers.

### Examples 5-1 to 5-5

As in Table 5, perpendicular magnetic recording media of examples 5-1 to 5-5 were manufactured through the same method as that of example 1 except that the material and thickness of amorphous layers were changed.

The nonmagnetic protective layer used in these examples was formed of Pt with a thickness of 1.5 nm. Using the same method of examples 2-1 to 2-4, Hc was measured to evaluate Hc decay. The following evaluation categories were noted according to how long it took for Hc to drop to 75% or less of its initial value. Seven days or less: ×; 8 to 20 days: Δ; more than 20 days: ◯. Table 5 shows the results.

TABLE 5

| | | | Time required | |
|---|---|---|---|---|
| | | Initial | until Hc drops | |
| | | Hc | to 75% of its | Evalu- |
| | Amorphous layer | [kOe] | initial value | ation |
| Example 5-1 | [Tb₃₀Co₇₀(1.5 nm)/ | 1.8 | More than | ◯ |
| | Pt(1.5 nm)]₁₀ | | 30 days | |
| Example 5-2 | [Tb₃₀Co₇₀(3 nm)/ | 2.4 | More than | ◯ |
| | Pt(1.5 nm)]₅ | | 30 days | |
| Example 5-3 | [Tb₃₀Co₇₀(5 nm)/ | 3.8 | More than | ◯ |
| (same as | Pt(1.5 nm)]₃ | | 30 days | |
| Example 1) | | | | |
| Example 5-4 | [Tb₃₀Co₇₀(7.5 nm)/ | 6.1 | 20 days | Δ |
| | Pt(1.5 nm)]₂ | | | |
| Example 5-5 | Tb₂₅Co₇₅(10 nm)/ | 7.5 | 14 days | Δ |
| | Pt(1.5 nm)/ | | | |
| | Tb₁₀Co₈₅Cr₅(7.5 nm) | | | |

As confirmed in Table 5, the Hc decay suppression effect of the embodiment was confirmed by changing the thickness of TbCo.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A perpendicular magnetic recording medium comprising:
a substrate;
an underlying layer including a plurality of convexes arranged on the substrate with intervals of 1 to 20 nm; and
a multilayered amorphous magnetic recording layer formed on the underlying layer,
wherein the multilayered amorphous magnetic recording layer includes a plurality of magnetic grains, each of the magnetic grains formed on a surface of a corresponding convex of the underlying layer to be widened toward an end thereof and having a magnetization easy axis in a direction perpendicular to a layer surface,
the magnetic grains are separated from each other at least in an area in the proximity of the convexes of the underlying layer, and
each of the magnetic particle includes a first amorphous magnetic recording layer, a nonmagnetic protective layer formed on the first amorphous magnetic recording layer to cover at least a part of a sidewall of the magnetic particle, and a second amorphous magnetic recording layer formed on the nonmagnetic protective layer.

2. The perpendicular magnetic recording medium of claim 1, wherein a combination of a nonmagnetic protective layer and an amorphous magnetic recording layer is additionally formed on the second amorphous magnetic recording layer, and the number of the combination varies from one to four.

3. The perpendicular magnetic recording medium of claim 1, wherein the nonmagnetic protective layer has a thickness of 0.5 to 3 nm.

4. The perpendicular magnetic recording medium of claim 1, wherein a total thickness of the nonmagnetic protective layer is less than or equal to one third of a total thickness of the amorphous magnetic recording layers and the nonmagnetic protective layer.

5. The perpendicular magnetic recording medium of claim 1, wherein the nonmagnetic protective layer is formed of at least one selected from a group consisting of platinum, palladium, gold, copper, chrome, and aluminum, and an alloy mainly containing platinum, palladium, gold, copper, chrome, and aluminum.

6. The perpendicular magnetic recording medium of claim 1, wherein the magnetic grains contact each other at tips thereof while being separated from each other in the area in the proximity of the convexes of the underlying layer over at least one third of the total thickness.

7. The perpendicular magnetic recording medium of claim 1, wherein dispersion of pitches of the convexes is less than or equal to 20%.

8. The perpendicular magnetic recording medium of claim 1, wherein the convex has a cross-sectional shape of either a half circle or a trapezoid.

9. The perpendicular magnetic recording medium of claim 1, wherein an amorphous magnetic recording material of the multilayered amorphous magnetic recording layer is a rare-earth element-transition metal alloy.

10. The perpendicular magnetic recording medium of claim 9, wherein the rare-earth element is at least one selected from a group consisting of samarium, gadolinium, terbium, and dysprosium.

11. The perpendicular magnetic recording medium of claim 9, wherein the transition metal is either iron or cobalt.

12. The perpendicular magnetic recording medium of claim 11, wherein the amorphous magnetic recording material is a terbium-cobalt alloy.

13. The perpendicular magnetic recording medium of claim 1, wherein the amorphous magnetic recording material contains an additional element of at least one selected from a group consisting of platinum, gold, silver, indium, chrome, titanium, silicon, and aluminum.

14. The perpendicular magnetic recording medium of claim 13, wherein an amount of additional element is less than or equal to 30 at % of an entire composition.

15. The perpendicular magnetic recording medium of claim 1, wherein the multilayered amorphous magnetic recording layer has a thickness of 3 to 30 nm.

16. The perpendicular magnetic recording medium of claim 1, wherein the gradient α of the magnetization curve in the proximity of a coercivity Hc is less than 5, as being represented by the following formula (1)
α=4πdM/dH|H=Hc (1)
where M is magnetization, H is external magnetic field, and Hc is coercivity.
